(19) United States
(12) Patent Application Publication
(10) Pub. No.: US 2011/0298768 A1
(43) Pub. Date: Dec. 8, 2011

(54) APPARATUS AND METHOD FOR DRIVING DISPLAY DEVICE

(75) Inventors: Jang-Hyun YEO, Seoul (KR); Po-Yun PARK, Asan-si (KR)

(73) Assignee: SAMSUNG ELECTRONICS CO., LTD., Suwon-si (KR)

(21) Appl. No.: 12/956,458

(22) Filed: Nov. 30, 2010

(30) Foreign Application Priority Data
Jun. 4, 2010 (KR) 10-2010-0052874

(51) Int. Cl. G09G 5/00; G09G 3/36

(52) U.S. Cl. 345/208; 345/87

(57) ABSTRACT

A driving apparatus of a display device, comprises a signal controller which receives an image signal and an input control signal from an outside, a signal error judgment unit which judges an error of the input control signal, and a data driver and a gate driver which receive a signal output from the signal controller, wherein the signal error judgment unit does not judge an error of the input control signal during a predetermined error judgment holding time after the error of the input control signal is generated and judges the error of the input control signal at the substantially a same time as when the error judgment holding time is terminated when the error of the input control signal is continued after the predetermined error judgment holding time.

This application claims priority to Korean Patent Application No. 10-2010-0052874, filed on Jun. 4, 2010, and all the benefits accruing therefrom under 35 U.S.C. §119, the content of which in its entirety is herein incorporated by reference.

### BACKGROUND OF THE INVENTION

(a) Field of the Invention

The present invention generally relates to an apparatus and a method for driving a display device.

(b) Description of the Related Art

A liquid crystal display (“LCD”), which is one type of flat panel displays that is being most widely used at present, typically includes two display panels including electric field generating electrodes such as a pixel electrode and a common electrode, for example, and a liquid crystal layer interposed between the display panels. An electric field is generated in the liquid crystal layer by applying voltage to the electric field generating electrodes, and determines an orientation of liquid crystal molecules in the liquid crystal layer and controls polarization of incident light through the electric field, thereby displaying an image.

A control signal and an image signal input into a flat panel display such as the LCD, for example, are appropriately controlled by a signal controller, and input into a display panel of the flat panel display. If the control signal input into the signal controller is an abnormal signal, various methods are proposed in order to prevent a defect of a displayed image, such methods including a method of inputting a predetermined compensation signal when a defect of the control signal occurs.

However, a minute defect may be recognized by a user due to inputting a predetermined compensation signal used to prevent a defect of the control signal even when the defect of the control signal due to static electricity, or other similar effects, for example, occurs for a substantially short time which can not be recognized by the user.

### BRIEF SUMMARY OF THE INVENTION

The present invention has been made in an effort to provide exemplary embodiments of apparatus and a method for driving a display device including advantages of preventing a deterioration of an image due to an unnecessary detection of an abnormal signal, by not detecting the abnormal signal if the abnormal signal is generated for a substantially short time which cannot be recognized by a user.

An exemplary embodiment of the present invention provides a driving apparatus of a display device that includes a signal controller receiving an image signal and an input control signal from an outside; a signal error judgment unit judging an error of the input control signal; and a data driver and a gate driver receiving a signal outputted from the signal controller, wherein the signal error judgment unit does not judge an error of the input control signal during a predetermined error judgment holding time after the error of the input control signal is generated, and judges the error of the input control signal at the substantially same time when the error judgment holding time is terminated if the error of the input control signal is continued even after the termination of the error judgment holding time.

In one exemplary embodiment, the signal error judgment unit may be included in the signal controller.

In one exemplary embodiment, the input control signal may include at least one of a vertical synchronization signal, a horizontal synchronization signal, a main clock signal, a data enable signal, and a clock lock signal.

In one exemplary embodiment, the error judgment holding time may be controlled by the number of flip-flops disposed in the signal error judgment unit.

In one exemplary embodiment, the error judgment holding time may be controlled by the number of divided clocks of an oscillator disposed in the signal error judgment unit.

In one exemplary embodiment, the number of divided clocks of the oscillator may be stored in a memory included in the signal error judgment unit.

In one exemplary embodiment, when the signal error judgment unit judges the error of the input control signal, the signal controller may output a predetermined image signal.

Another exemplary embodiment of the present invention provides an exemplary embodiment of a driving method of a display device that includes inputting an image signal and an input control signal from outside into a signal controller; judging an error of the input control signal; and outputting a predetermined image signal when the input control signal has an error, wherein a signal error judgment unit counts a predetermined error judgment holding time when the error of the input control signal is generated, and judges the error of the input control signal thereafter at the substantially same time when the predetermined error judgment holding time is terminated if the error of the input control signal is continued even after the error judgment holding time.

The exemplary embodiments according to the present invention may prevent an image from being deteriorated due to an unnecessary detection of an abnormal signal by not detecting the abnormal signal if the abnormal signal occurs for a substantially short time which cannot be recognized by a user.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a block diagram of an exemplary embodiment of a display device according to the present invention;

FIG. 2 is an equivalent circuit diagram of one pixel of a plurality of pixels included in an exemplary embodiment of the display device according to the present invention;

FIG. 3 is a block diagram illustrating an operation of an exemplary embodiment of an error judgment unit 650 according to the present invention;

FIGS. 4A and 4B are waveform diagrams illustrating an exemplary embodiment of a signal error judgment operation of an exemplary embodiment of a driver of a display device according to the present invention;

FIGS. 5A and 5B are diagrams for describing an exemplary embodiment of a setting of an error judgment holding time of an input control signal;

FIGS. 6A to 6C are waveform diagrams for describing exemplary embodiments of a control signal error judgment operation according to the present invention; and

FIG. 7 is a waveform diagram for describing another exemplary embodiment of the control signal error judgment operation according to the present invention.

### DETAILED DESCRIPTION OF THE INVENTION

The present invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular exemplary embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized exemplary embodiments. As such, variations from the shapes of the illustrations as a result, for example, of manufacturing techniques and/or tolerances, are to be expected. Thus, exemplary embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

In the drawings, a thickness of layers, films, panels, regions, and various other parts may be exaggerated for clarity. Like reference numerals designate like elements throughout the specification.

Hereinafter, an exemplary embodiment of a liquid crystal display (“LCD”) according to the present invention will be described in detail with reference to the accompanying drawings.

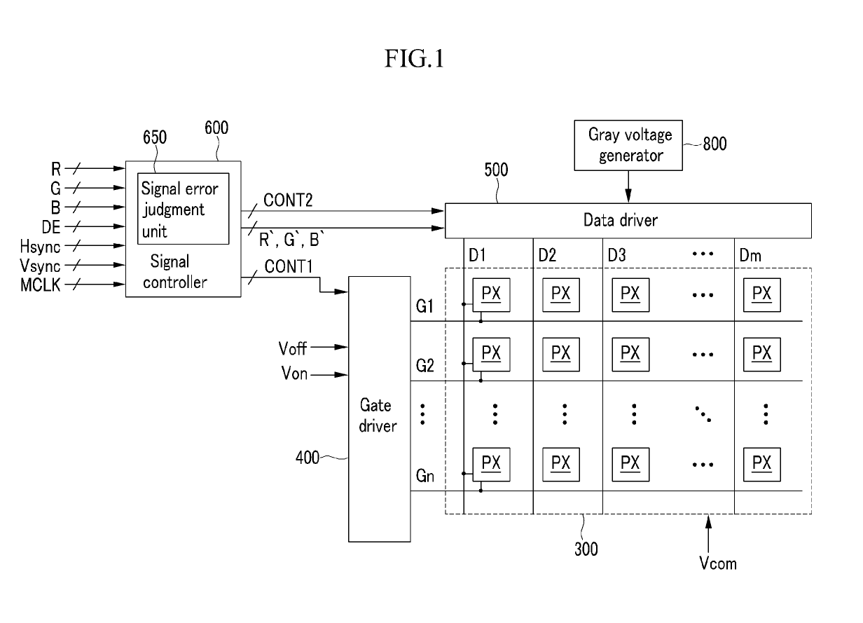

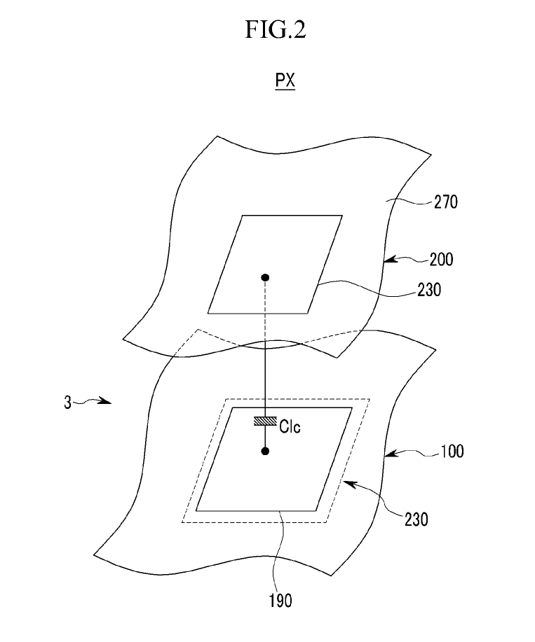

First, referring to FIGS. 1 and 2, an exemplary embodiment of a display device according to the present invention will be described in detail.

FIG. 1 is a block diagram of an exemplary embodiment of the display device according to the present invention and FIG. 2 is an equivalent circuit diagram of an exemplary embodiment of one pixel of the plurality of pixels included in the exemplary embodiment of the display device according to the present invention.

Referring to FIG. 1, the exemplary embodiment of the display device according to the present invention includes a display panel assembly 300, a gate driver 400, a data driver 500, a gray voltage generator 800, and a signal controller 600. The signal controller 600 includes a signal error judgment unit 650.

Referring to FIG. 1, the exemplary embodiment of the display panel assembly 300 includes a plurality of signal lines G₁ to Gₙ and D₁ to Dₘ and a plurality of pixels PX that is connected to the plurality of signal lines signal lines G₁ to Gₙ and D₁ to Dₘ and arranged substantially in the form of a matrix as shown in FIG. 1. Referring to FIG. 2, an exemplary embodiment of the display panel assembly 300 includes lower display panel 100 and upper display panel 200 facing each other and a liquid crystal layer 3 interposed therebetween. In the exemplary embodiment shown in FIG. 2, the LCD is described as an example, but all the exemplary embodiments according to the present invention are applicable to all types of flat panel displays such as a plasma display panel (“PDP”), an organic light emitting diode (“OLED”) display, and various other types of flat panel displays in addition to the liquid crystal display.

The plurality of signal lines G₁ to Gₙ and D₁ to Dₘ includes a plurality of gate lines G₁ to Gₙ transmitting a gate signal (also referred to as a “scan signal”) and a plurality of data lines D₁ to Dₘ transmitting data voltage. The plurality of gate lines G₁ to Gₙ extends substantially along a row direction and substantially parallel to each other and the plurality of data lines D₁ to Dₘ extends substantially along a column direction and are substantially parallel to each other.

Each pixel of the plurality of pixels PX that is connected to an i-th (i=1, 2, . . . , n) gate line Gᵢ and a j-th (j=1, 2, . . . , m) data line includes a switching element connected to the signal lines Gᵢ and Dⱼ, and a liquid crystal capacitor Clc and a storage capacitor Cst (not shown) connected thereto. In one exemplary embodiment, the storage capacitor may be omitted.

The switching element, a three terminal element (not shown) such as a thin film transistor (“TFT”), for example, provided on the lower display panel 100 has a control terminal connected to the gate line Gᵢ, an input terminal connected with the data line Dⱼ, and an output terminal connected with the liquid crystal capacitor Clc and the storage capacitor Cst (not shown).

The liquid crystal capacitor Clc uses a pixel electrode 190 of the lower display panel 100 and a common electrode 270 of the upper display panel 200. The liquid crystal layer 3 interposed between the two electrodes 190 and 270 functions as a dielectric. The pixel electrode 190 is connected with the switching element, and the common electrode 270 is formed on an overall surface of the upper display panel 200 and receives common voltage Vcom. In one exemplary embodiment, the common electrode 270 may be provided on the lower display panel 100. In the present exemplary embodiment, at least one of the two electrodes 190 and 270 may have a linear shape or a bar shape.

The storage capacitor Cst is an auxiliary storage capacitor for the liquid crystal capacitor Clc and is formed by overlapping an additional signal line (not shown) and a portion of the pixel electrode 190 that are provided on the lower display panel 100 with an insulator interposed therebetween. A predetermined voltage such as the common voltage Vcom, for example, is applied to the additional signal line. In one exemplary embodiment, the storage capacitor may be formed by overlapping a portion of the pixel electrode 190 with a previous gate line Gᵢ₋₁ with the insulator interposed therebetween.

To implement a color display, each pixel of the plurality pixels PX uniquely displays one of primary colors using spatial division, for example, or each pixel of the plurality pixels PX alternately displays one or more of the primary colors depending on time using temporal division to represent a desired color through spatial and temporal sums of the primary colors. In one exemplary embodiment, the primary colors may include three primary colors of red (R), green (G), and blue (B) colors.

In one exemplary embodiment, at least one polarizer (not shown) is provided in the LCD panel assembly 300.

Hereinafter, an exemplary embodiment of an apparatus for driving a display device according to the present invention will be described in more detail.

Referring back to FIG. 1, the gray voltage generator 800 either generates entire gray scale voltages relating to the transmittance of the pixel PX or a limited number of gray scale voltages, depending on a particular embodiment. In one exemplary embodiment, the gray scale voltages may include voltage having a positive value or a negative value with respect to the common voltage Vcom.

The gate driver 400 is connected with the plurality of gate lines G₁ to Gₙ of the LCD panel assembly 300 applying the gate signal constituted by combination of gate-on voltage Von and gate-off voltage Voff to the plurality of gate lines G₁ to Gₙ.

The data driver 500 is connected with the plurality of data lines D₁ to Dₘ of the LCD panel assembly, and selects gray voltage from the gray voltage generator 800 and applies the plurality of data lines D₁ to Dₘ as data voltage. In one exemplary embodiment, when the gray voltage generator 800 does not provide all gate voltage but provides the limited number of gray scale voltages, the data driver 500 generates desired data voltage by dividing the provided limited number of gray scale voltages.

The signal controller 600 controls the gate driver 400 and the data driver 500. The signal controller 600 includes the signal error judgment unit 650.

In one exemplary embodiment, each of the drivers 400, 500, 600, and 800 may be mounted directly on the LCD panel assembly 300 in the form of at least one integrated circuit (“IC”) chip, mounted on a flexible printed circuit film (“FPCF”)(not shown) and attached to the LCD panel assembly 300 in the form of a tape carrier package (“TCP”), or mounted on an additional printed circuit board (not shown). In one exemplary embodiment, the drivers 400, 500, 600, and 800 may be integrated on the LCD panel assembly 300 together with the signal lines G₁ to Gₙ and D₁ to Dₘ and the thin film transistor (“TFT”) switching elements. In one exemplary embodiment, the drivers 400, 500, 600, and 800 may be integrated as a single chip. In one exemplary embodiment, at least one of them or at least one circuit element constituting them may be installed outside of the single chip.

Hereinafter, an exemplary embodiment of an operation of the display device will be described in detail.

The signal controller 600 receives input image signals R, G, and B and input control signals for controlling the display thereof from an external graphic controller (not shown). The input image signals R, G, and B contain luminance information of each pixel of the plurality pixels PX and the luminance has gray scales of a predetermined number, for example, 1024 (=2¹⁰), 256 (=2⁸), or 64 (=2⁶). In one exemplary embodiment, the input control signals include a vertical synchronization signal Vsync and a horizontal synchronization signal Hsync, a main clock signal MCLK, a data enable signal DE, and other similar signals.

The signal controller 600 processes the input image signals R, G, and B properly in accordance with an operation condition of the LCD panel assembly 300 on the basis of the input image signals R, G, and B, and the input control signals and generates a gate control signal CONT1 and a data control signal CONT2 and transmits the gate control signal CONT1 to the gate driver 400 and transmits the data control signal CONT2 and processed image signals R′, G′, and B′ to the data driver 500. Alternative exemplary embodiments include configurations wherein the gate control signal CONT1 and the data control signal CONT2 are both transmitted to one or the other of the gate driver 400 and the data driver 500 and subsequently transmitted to the other of the gate driver 400 and the data driver 500.

In the present exemplary embodiment, the signal error judgment unit 650 of the signal controller 600 judges and detects an error of the input control signal, thereby transmitting a predetermined compensation signal when the error occurs and a further description thereof will be described below.

The gate control signal CONT1 includes a scanning start signal STV directing a scanning start and at least one clock signal for controlling an output cycle of the gate-on voltage Von. In one exemplary embodiment, the gate control signal CONT1 may also further include an output enable signal OE for limiting a duration time of the gate-on voltage Von.

The data control signal CONT2 includes a horizontal synchronization signal STH for directing a transmission start of the digital image signal DAT for one row of the plurality of pixels PX, a load signal LOAD for applying analog data voltage to the plurality of data lines D₁-Dₘ, and a data clock signal HCLK. In one exemplary embodiment, the data control signal CONT2 may also further include an inversion signal RVS for inverting a polarity of the data voltage with respect to the common voltage Vcom (hereinafter, also referred to as “the polarity of the data voltage” acquired by abbreviating “the polarity of the data voltage with respect to the common voltage”).

In accordance with the data control signal CONT2 from the signal controller 600, the data driver 500 receives the processed image signals R′, G′, and B′ for one row of the plurality of pixels PX, selects gray voltage corresponding to each of the processed image signals R′, G′, and B′, converts the processed image signals R′, G′, and B′ into analog data voltage, and applies the converted analog data voltage to the corresponding data lines D₁ to Dₘ.

The gate driver 400 applies the gate-on voltage Von to the gate lines G₁ to Gₙ in accordance with the gate control signal CONT1 from the signal controller 600 to turn on the switching element connected to the plurality of gate lines G₁ to Gₙ. Then, the data voltage applied to the plurality of data lines D₁ to Dₘ is applied to a corresponding pixel PX of the plurality of pixels PX through the switching element which is turned on.

A difference between the data voltage applied to the plurality of the pixels PX and the common voltage Vcom is represented as charging voltage of the liquid crystal capacitor Clc, i.e., a pixel voltage. An arrangement of liquid crystal molecules depends on an amplitude of the pixel voltage and thus, polarization of light passing through the liquid crystal layer 3 is controlled. The polarization change is represented as a change of transmittance of light, and resultantly, the plurality of the pixel PX displays luminance represented by gray scale voltage of the image signal DAT.

By repetitively performing the above mentioned process using a unit of the first horizontal period (also written as “1H”, equivalent to one period of the horizontal synchronization signal Hsync and the data enable signal DE), the gate-on voltage Von is sequentially applied to the plurality of gate lines G₁ to Gₙ and the data voltage is applied to the plurality of the pixels PX, thereby displaying an image of one frame.

In one exemplary embodiment, when one frame is ended, a subsequent frame is started. A state of the inversion signal RVS applied to the data driver 500 is controlled so that a polarity of the data voltage applied to each pixel of the plurality of pixels PX is opposite to the polarity of a data voltage in the previous frame, i.e., frame inversion. In the present exemplary embodiment, a polarity of the data voltage that flows through one data line is periodically changed, e.g., row inversion or dot inversion, or the polarities of data voltage applied to one pixel line of the plurality of pixels PX may also be different from each other, e.g., column inversion or dot inversion, depending on the characteristics of the inversion signal RVS even in one frame.

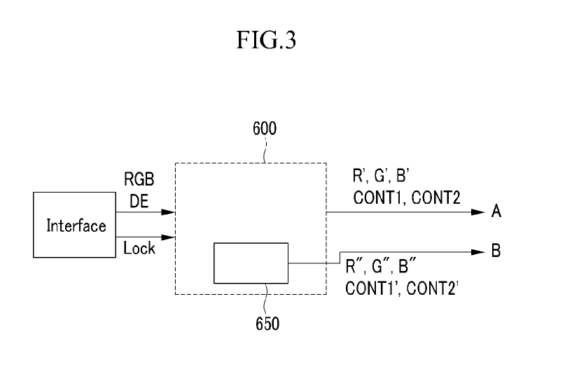

Then, hereinafter, referring to FIGS. 3 to 6C, an exemplary embodiment of a process of a judgment and a compensation of the signal error of the signal error judgment unit 650 included in the signal controller 600 in the display device according to the present invention will be described.

FIG. 3 is a block diagram illustrating an exemplary embodiment of an operation of an error judgment unit 650 according to the present invention.

Referring to FIG. 3, an exemplary embodiment of the signal controller 600 receives input image signals R, G, and B and an input control signal for controlling the display from an external interface. In one exemplary embodiment, the input control signal may include a vertical synchronization signal Vsync and a horizontal synchronization signal Hsync, a main clock signal MCLK, a data enable signal DE, and a clock lock signal Lock.

The exemplary embodiment of the signal error judgment unit 650 included in the signal controller 600 judges whether an input input control signal is a normal signal (A) or an abnormal signal (B), and when the input control signal is the normal signal A, the signal controller 600 processes the input image signals R, G, and B on the basis of the input input control signal and transmits a gate control signal CONT1 and a data control signal CONT2, and processed image signals R′, G′, and B′.

If the input control signal is the abnormal signal B, the signal controller 600 transmits a compensated gate control signal CONT1′ and a compensated data control signal CONT2′, and compensated image signals R″, G″, and B″.

The compensated image signals R″, G″, and B″ set in the signal controller 600 may display the plurality of pixels PX of the display panel 300 in white or black, or substantially same values as an image signal of the current frame. In one exemplary embodiment, the compensated image signals R″, G″, and B″ may be signals having predetermined values.

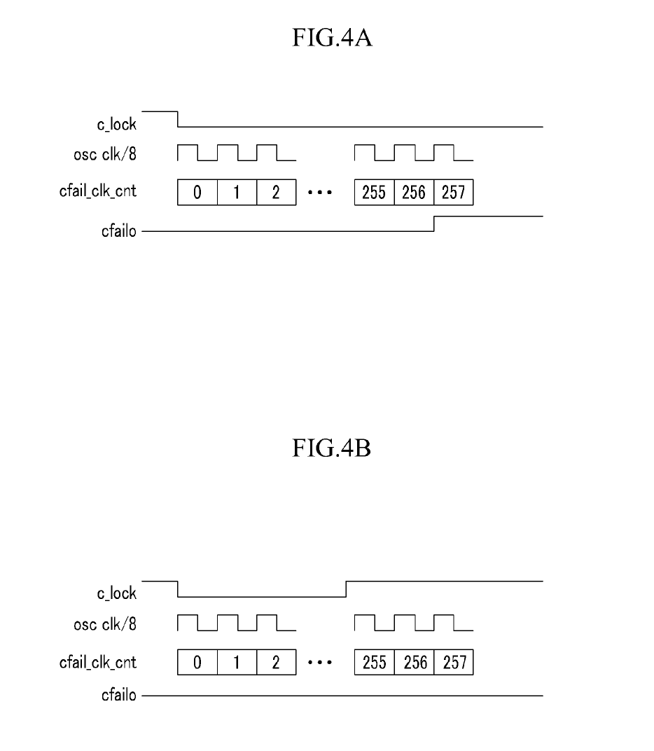

Hereinafter, the exemplary embodiment of the operation of the signal error judgment unit 650 according to the present invention will be further described in detail with reference to FIGS. 4A and 4B. FIGS. 4A and 4B are waveform diagrams illustrating an exemplary embodiment of a signal error judgment operation of a driver of a display device according to the present invention. In the present exemplary embodiment, the clock lock signal may be described as an example but other clock signals may be used.

As shown in FIG. 4A, when the input control signal, i.e., a clock lock signal c_lock is changed from a normal range (high) to an abnormal range (low), the exemplary embodiment of the signal error judgment unit 650 of the driver of the display device according to the present invention holds the error judgment during a predetermined time after the corresponding signal is changed to the abnormal range, i.e., the error judgment holding time of the input control signal c_lock and the signal error judgment unit 650 judges that the input control signal c_lock has an error when the input control signal c_lock is continuous in the abnormal range even after the error judgment holding time is ended.

In one exemplary embodiment, the error judgment holding time of the input control signal may be set by controlling the number of clock cycles of an oscillator (not shown) by using the oscillator disposed in the signal controller 600. In the exemplary embodiment shown in FIG. 4A, the error judgment holding time of the input signal is set to approximately 256 clocks.

Although not shown, another exemplary embodiment of the error judgment holding time of the input signal may be set using a flip-flop (not shown) according to the present invention. In such an exemplary embodiment, the error judgment holding time depends on the number of flip-flops, i.e., the more the flip-flops are, the longer the error judgment holding time is.

As shown in FIG. 4A, an error judgment signal cfailo is in an off state until the number of clocks cfail_clk_cnt of the oscillator reaches 256 after the input clock lock signal c_lock is changed to the abnormal range (low), and the error judgment signal cfailo is changed to an ON state if the input clock lock signal c_lock is still in the abnormal range (low) even after the number of clock s cfail_clk_cnt of the oscillator reaches 256, such that the signal controller 600 judges that the input clock lock signal c_lock has an error.

Referring to FIG. 4B, if the input clock lock signal c_lock is changed from the normal range (high) to the abnormal range (low) and when the input clock lock signal c_lock is restored to the normal range (high) again at a predetermined value of the number of clock cycles of the oscillator, i.e., at 244 clocks of the number of clocks cfail_clk_cnt reaches 256 clocks, the error judgment signal cfailo is still in the off state, such that an error which is restored to the normal range within the error judgment holding time is not detected.

Therefore, the signal error judgment unit 650 does not judge the input clock lock signal c_lock as an error if the error of the input clock lock signal c_lock occurs for a predetermined short time which a user can not recognize that the error occurs, and as a result, the input clock lock signal c_lock may not be compensated. The present exemplary embodiment of the signal error judgment unit 650 of the driver of the display device according to the present invention does not detect a defect of the signal which occurs for a substantially short time which cannot be recognized by the user so as to prevent an image from being deteriorated by an unnecessary signal detection.

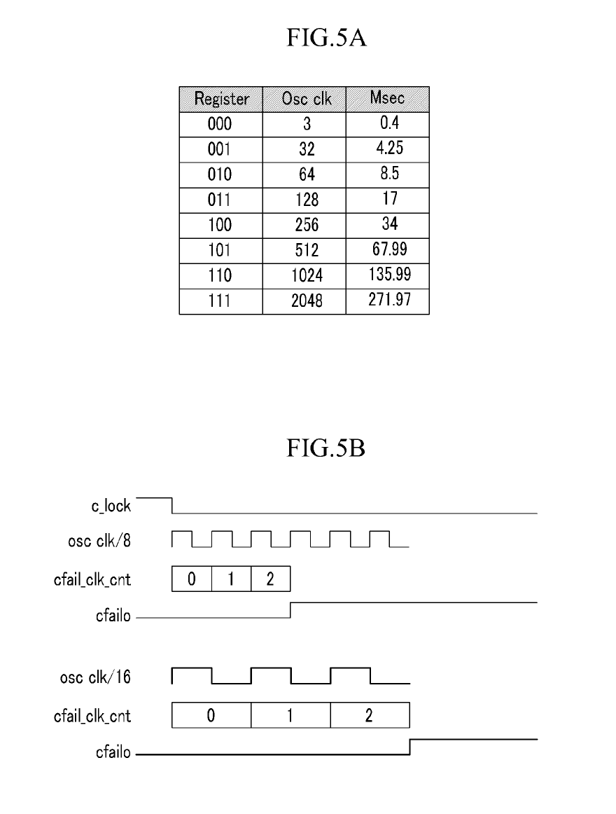

Hereinafter, referring to FIGS. 5A and 5B, an exemplary embodiment of a setting of an error judgment holding time of an input signal will be described. FIGS. 5A and 5B are diagrams describing an exemplary embodiment of the setting of an error judgment holding time of an input signal.

The exemplary embodiment of the error judgment holding time of the signal error judgment unit 650 of the driver of the display device according to the present invention may be set by using the number of clock cycles acquired by dividing a clock of the oscillator in the signal controller. In one exemplary embodiment, as described above, the error judgment holding time of the input control signal may be set by using a flip-flop in another exemplary embodiment of the present invention. In the present exemplary embodiment, the error judgment holding time depends on the number of flip-flops, i.e., the more the flip-flops are, the longer the error judgment holding time is.

In one exemplary embodiment of the setting of the number of clock cycles acquired by dividing the clock of the oscillator, when a 3-bit memory register is assigned to a memory in the signal controller 600, eight settings may be available. In the exemplary embodiment shown in FIG. 5A, the clock of the oscillator is divided by 8. In one exemplary embodiment, as shown in FIG. 5A, the number of clock cycles dividing the clock of the oscillator may be set to 3 to 2048, and as a result, the error judgment holding time of the input control signal may be set from about 0.4 microseconds (μs) to about 271.97 μs.

In the present exemplary embodiment, the number of clock cycles of the oscillator is set by assigning the registering of the memory in the signal controller, such that the error judgment holding time of the input control signal may be set without an additional device or cost.

Referring to FIG. 5B, an exemplary embodiment of the clock of the oscillator in the signal controller divided by 8 is compared with an exemplary embodiment of the clock of the oscillator in the signal controller divided by 16. An exemplary embodiment of the clock of the oscillator divided by 8 is shown in an upper side of FIG. 5B and an exemplary embodiment of the clock of the oscillator divided by 16 is shown in a lower side of FIG. 5B. Accordingly, a desired error judgment holding time of an input control signal using the number of divided clocks of a substantially small oscillator may be set. As described above, the desired error judgment holding time may be set by dividing the number of clock cycles of the oscillator by 8, 16, 32, or other natural numbers.

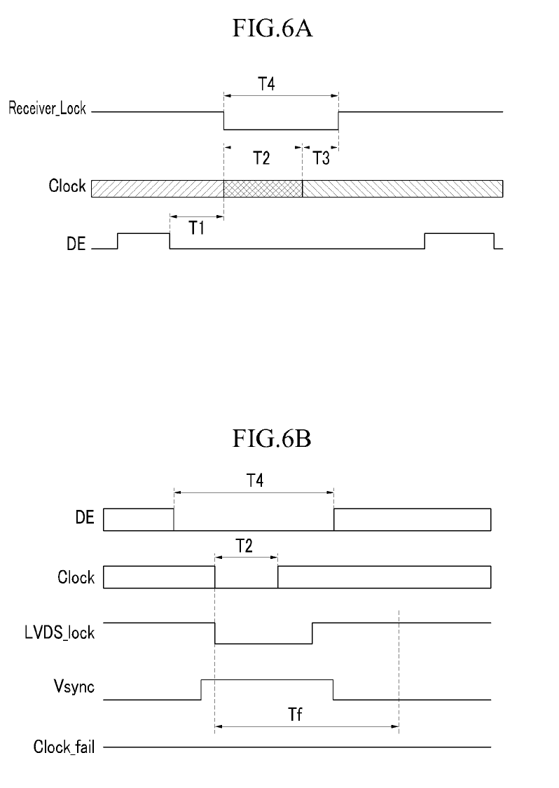

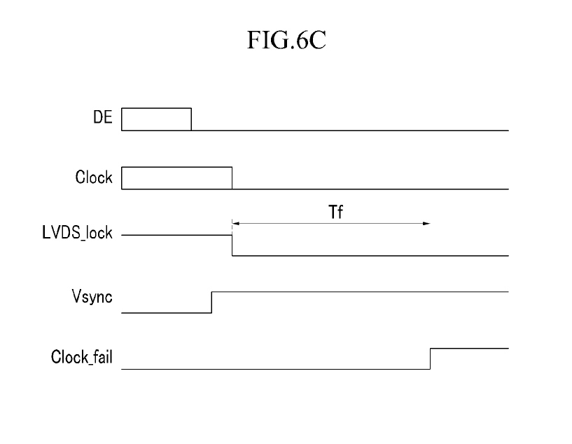

Next, referring to FIGS. 6A to 6C, another exemplary embodiment of a control signal error judgment operation according to the present invention will be described. FIGS. 6A to 6C are waveform diagrams describing another exemplary embodiment of a control signal error judgment operation according to the present invention.

Referring to FIG. 6A, an exemplary embodiment of the driver of the display device may change an input clock. In the exemplary embodiment, when an image that is continuously changing, such as a moving picture or another type of a moving image, for example, is displayed, an image signal is transmitted with a first clock, and when an image which is slightly changed such as a still image, for example, is displayed, an image signal is transmitted as a second clock representing a frame frequency lower than a frame frequency of the first clock. The present exemplary embodiment of the driver of the display device may substantially save driving power through the change of a driving frequency.

In one exemplary embodiment, it may be beneficial that the change of the driving frequency is performed during a vertical blank period. In the present exemplary embodiment, a vertical blank period T4 is started when a first time T1 has passed after the data enable signal DE for inputting an image signal a first frame is off in the last line of a first frame, and the vertical blank period T4 is ended when a third time T3 has passed after an input frequency is changed during a second time T2 after the vertical blank period T4 is started.

In the present exemplary embodiment, the second time T2 as a stabilization section for changing the driving frequency after the vertical blank period T4 is started may have a maximum value of about 100 μs.

In the present exemplary embodiment, when the driving frequency is changed, the stabilization section is used for a frequency changing section and since the clock signal is not input in the stabilization section, the signal error judgment unit 650 of the driver may judge the stabilization section as an abnormal input control signal. However, in the exemplary embodiment of the driver of the display device according to the present invention, by setting the error judgment holding time longer than the time of the stabilization period in the frequency changing section during the vertical blank time T4, the stabilization period may not be judged as the abnormal signal by holding the judgment of the error of the input control signal during the stabilization period.

Hereinafter, the present exemplary embodiment will be further described with reference to FIGS. 6B and 6C.

Referring to FIG. 6B, the exemplary embodiment of the operation of the signal error judgment unit 650 when the driving frequency is changed will be described. It is assumed that the clock frequency is changed from a first frequency, e.g., 60 Hz, to a second frequency, e.g., 40 Hz. In the present exemplary embodiment, a stabilization period T2 for changing the clock frequency between the first frequency and the second frequency may be approximately 100 μs. In the present exemplary embodiment, the error judgment holding time Tf for holding the error judgment of the input control signal is longer than the stabilization period T2.

Therefore, although the clock signal is not input during the stabilization period T2 before the clock frequency is changed from the first frequency 60 Hz to the second frequency 40 Hz, the stabilization period T2 is shorter than the error judgment holding time. Therefore, the signal error judgment unit 650 does not judge that the clock signal has an error during the error judgment holding time Tf.

In one exemplary embodiment, referring to FIG. 6C, when a frequency is not changing but an abnormal period of the clock signal actually occurs, the clock signal is not input during the error judgment holding time after the clock signal is not input. Therefore, in the present exemplary embodiment, a clock signal error signal Clock_fail is turned on while the error judgment holding time is ended and as a result, the error of the clock signal is judged.

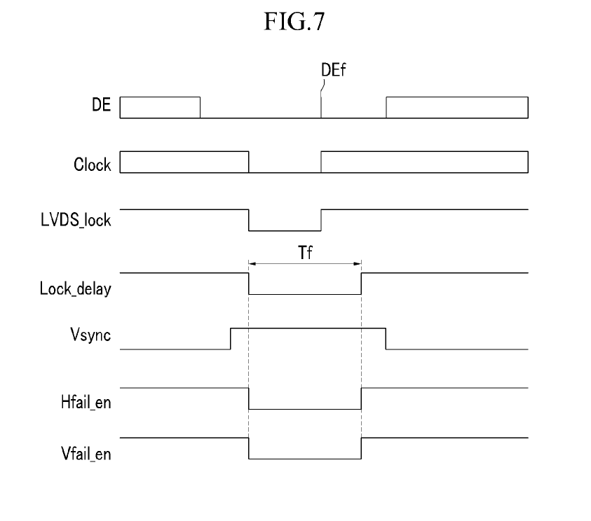

Next, referring to FIG. 7, another exemplary embodiment of a control signal error judgment operation according to the present invention will be described. FIG. 7 is a waveform diagram for describing an exemplary embodiment of a control signal error judgment operation according to the present invention.

FIG. 7 illustrates an exemplary embodiment in which an instantaneous error Def of the data enable signal DE occurs within the vertical blank period in which the clock frequency is changed from the first frequency to the second frequency. In the present exemplary embodiment, the data enable signal DE is turned on due to the instantaneous error Def of the data enable signal DE even in a blank period, such that it is misrecognized that the vertical synchronization signal Vsync and the horizontal synchronization signal Hsync are input. In the present embodiment, since the vertical synchronization signal Vsync and the horizontal synchronization signal Hsync are not actually input because the vertical blank period is the blank period, the signal error judgment unit 650 of the driver may judge that the vertical synchronization signal Vsync and the horizontal synchronization signal Hsync have the errors.

However, since the exemplary embodiment of the signal error judgment unit 650 of the driver of the display device according to the present invention holds the judgment that the signal has the error although the signal is not input during a predetermined error judgment holding time, the signal error judgment unit 650 does not judge that the vertical synchronization signal Vsync and the horizontal synchronization signal Hsync have the errors.

In the present exemplary embodiment, since it may arbitrarily set the error judgment holding time in order to prevent the signal error judgment unit from judging the error of the control signal which occurs for a substantially short time due to an instantaneous cause such as static electricity, or other similar causes, it may prevent an image from being deteriorated by the unnecessary detection of an signal defect without an additional device or cost.

In the above, although exemplary embodiments of the display device including the LCD panel has been described, the exemplary embodiments of the present invention are applicable to all types of display devices that display an image by using an image signal and a control signal.

While exemplary embodiments of the present invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A driving apparatus of a display device, comprising:
a signal controller which receives an image signal and an input control signal from an outside;
a signal error judgment unit which judges an error of the input control signal; and
a data driver and a gate driver which receive a signal output from the signal controller,
wherein the signal error judgment unit does not judge an error of the input control signal during a predetermined error judgment holding time after the error of the input control signal is generated and judges the error of the input control signal at the substantially a same time as when the error judgment holding time is terminated when the error of the input control signal is continued after the predetermined error judgment holding time.

2. The driving apparatus of claim 1, wherein:
the signal error judgment unit is included in the signal controller.

3. The driving apparatus of claim 2, wherein:
the input control signal includes at least one of a vertical synchronization signal, a horizontal synchronization signal, a main clock signal, a data enable signal, and a clock lock signal.

4. The driving apparatus of claim 2, wherein:
the error judgment holding time is controlled using a number of flip-flops disposed in the signal error judgment unit.

5. The driving apparatus of claim 2, wherein:
the error judgment holding time is controlled using a number of divided clock signals of an oscillator disposed in the signal error judgment unit.

6. The driving apparatus of claim 5, wherein:
the number of divided clock signals of the oscillator is stored in a memory included in the signal error judgment unit.

7. The driving apparatus of claim 2, wherein:
the signal controller outputs a predetermined image signal when the signal error judgment unit judges the error of the input control signal.

8. The driving apparatus of claim 1, wherein:
the input control signal includes at least one of a vertical synchronization signal, a horizontal synchronization signal, a main clock signal, a data enable signal, and a clock lock signal.

9. The driving apparatus of claim 1, wherein:
the error judgment holding time is controlled using a number of flip-flops disposed in the signal error judgment unit.

10. The driving apparatus of claim 1, wherein:
the error judgment holding time is controlled using a number of divided clock signals of an oscillator disposed in the signal error judgment unit.

11. The driving apparatus of claim 10, wherein:
the number of divided clock signals of the oscillator is stored in a memory included in the signal error judgment unit.

12. The driving apparatus of claim 1, wherein:
the signal controller outputs a predetermined image signal when the signal error judgment unit judges the error of the input control signal.

13. A driving method of a display device, the method comprising:
inputting an image signal and an input control signal from an outside into a signal controller;
judging an error of the input control signal; and
outputting a predetermined image signal when the input control signal has the error,
wherein a signal error judgment unit counts a predetermined error judgment holding time after the error of the input control signal is generated, and judges the error of the input control signal at substantially a same time when the error judgment holding time is terminated when the error signal of the input control signal is continued during the error judgment holding time.

14. The driving method of claim 13, wherein:
the signal error judgment unit is included in the signal controller.

15. The driving method of claim 14, wherein:
the input control signal includes at least one of a vertical synchronization signal, a horizontal synchronization signal, a main clock signal, a data enable signal, and a clock lock signal.

16. The driving method of claim 14, wherein:
the error judgment holding time is controlled using a number of flip-flops disposed in the signal error judgment unit.

17. The driving method of claim 14, wherein:
the error judgment holding time is controlled using a number of divided clock signals of an oscillator disposed in the signal error judgment unit.

18. The driving method of claim 17, wherein:
the number of divided clock signals of the oscillator is stored in a memory included in the signal error judgment unit.

19. The driving method of claim 13, wherein:
the input control signal is at least one of a vertical synchronization signal, a horizontal synchronization signal, a main clock signal, a data enable signal, and a clock lock signal.

20. The driving method of claim 13, wherein:
the error judgment holding time is controlled using a number of flip-flops disposed in the signal error judgment unit.

21. The driving method of claim 13, wherein:
the error judgment holding time is controlled using a number of divided clock signals of an oscillator disposed in the signal error judgment unit.

22. The driving method of claim 21, wherein:
the number of divided clock signals of the oscillator is stored in a memory included in the signal error judgment unit.
